(19) United States
(12) Patent Application Publication
(10) Pub. No.: US 2018/0257013 A1
(43) Pub. Date: Sep. 13, 2018

(54) SHAKER SCREEN FRAME WITH CIRCULAR MEMBER

(71) Applicants: Grant Young, Tulsa, TN (US); Ray Young, Glenpool, OK (US)

(72) Inventors: Grant Young, Tulsa, TN (US); Ray Young, Glenpool, OK (US)

(21) Appl. No.: 15/456,222

(22) Filed: Mar. 10, 2017

(51) Int. Cl. B01D 33/03; B01D 33/80

(52) U.S. Cl. CPC B01D 33/03; B01D 2201/0415; B01D 33/80

(57) ABSTRACT

A screen, for a vibrating screen device, has a frame and a screen surface. The frame has a periphery and a middle portion wherein the periphery is constructed of elongate material portions. The middle portion has middle supports including tubing having a cross-section of an ovular shape.

### CROSS-REFERENCE TO RELATED APPLICATIONS

Not Applicable

### STATEMENT REGARDING FEDERALLY SPONSORED RESEARCH

Not Applicable

### FIELD OF THE INVENTION

This invention relates to shakers for separating solids from a fluid.

### BACKGROUND OF THE INVENTION

Shakers or vibrating screen devices can be used to separate solids from liquid. Some shakers have multiple screens with a screen/mesh for separating the solids from the liquid. The liquid passes through the screen/mesh and the solids remain atop the screen/mesh. Most of these screens are built of square and/or rectangular tubing. For example, a one inch square tube often forms the periphery of the screen. Support across the middle of the screen is commonly formed of ½ inch by 1 inch rectangular tube. This frame is often bonded to a perforated plate typically having a screen bonded to the perforated plate.

Flow can be reduced due to the width of the rectangular members. Further the rectangular tubing generally does not resist twisting forces symmetrically; this can reduce the torsional rigidity of the screen frame.

There is a need for screens and/or frames that improve the flow through a screen and can increase the torsional rigidity of the screen frame.

The instant invention, as disclosed within this application, provides a screen frame that fills this need. The art referred to and/or described within this application is not intended to constitute an admission that any patent, publication or other information referred to herein is “prior art” with respect to this invention. In addition, this section should not be construed to mean that a thorough search has been made or that no other pertinent information as defined in 37 C.F.R. § 1.56(a) exists.

All US patents and applications and all other published documents mentioned anywhere in this application are incorporated herein by reference in their entirety.

Without limiting the scope of the invention, a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well, only for the purposes of complying with 37 C.F.R. 1.72. The abstract is not intended to be used for interpreting the scope of the claims.

### BRIEF SUMMARY OF THE INVENTION

In at least one embodiment of the invention, the vibratory screen may have a frame and a screen surface. The frame may have a periphery and a middle portion wherein the periphery may be constructed of elongate material. Additionally, the middle portion may have middle supports including tubing having a cross-section of an ovular shape.

In at least one embodiment of the invention, the periphery may be constructed of rectangular tubing having transverse portions and longitudinal portions.

In at least one embodiment, the periphery is constructed of angle or U-shaped material having transverse portions and longitudinal portions.

In at least one embodiment of the invention, half or more of the middle supports may have a cross-section of an ovular shape.

In at least one embodiment of the invention, the middle supports may extend transversely between longitudinally extending portions of the frame.

In at least one embodiment of the invention, the middle supports may have a cross-section of a shape selected from a group having a shape that is round, substantially circular, substantially semi-circular, substantially elliptical, egg-shaped, oval, or any combination thereof.

In at least one embodiment of the invention, the screen surface may be supported by a perforated plate.

In at least one embodiment of the invention, the middle supports may contact the perforated plate at contact points that are less than one half the widest width of the middle supports in cross section.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE SEVERAL VIEWS OF THE DRAWING(S)

A detailed description of the invention is hereafter described with specific reference being made to the drawing.

FIG. 1a is a top view of a standard screen frame

FIG. 1b is a cross-sectional side view of a standard screen frame illustrating rectangular middle supports.

FIG. 2 is a top view of a standard plate

FIG. 3a is a top view of a screen frame with a perforated plate on top.

FIG. 3b is a cross-section side view of a screen frame with a perforated plate on top.

FIG. 4 is a cross-section side view of a screen frame with a perforated plate and screen fabric on top.

FIG. 5 is a cross-section side view of a screen frame with a perforated plate and screen fabric on top.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated. In some embodiments, the basket can have its sides defined by the sides of the vibrating screen device disposed under one or a plurality of screens. Any stepped down configuration can include different levels of screens wherein there is an uppermost level and a lowermost level. These steps can proceed in a straight line or in other configurations (e.g. spiraling down steps). Additionally, within this application the term “proximal” end of the shaker is the end in which the material to be separated is introduced; the “distal” end of the shaker is the end toward which the separated solids are conveyed. The “proximal” and “distal” terms can also be applied to baskets, screens, and frames with the same orientation.

The use of the term(s) oval or ovular includes (but is not limited to) shapes that are: not quite circular, egg shaped, of the appearance of a mashed/deformed circle, circular, and/or elliptical. The use of the term “perforated plate” does not indicate a form of manufacture; it indicates a plate that has holes or pores there through. “Elongate material” is a material having a length substantially greater than its width. In some instances the length to width ratio is greater than 10 to 1. In some instances it is greater than 30 to 1. Elongate material can also be comprised of shorter connected materials (e.g. pieces that are closer to a 1 to 1 width to length ratio) that are aligned in the substantially same direction. The cross section of the elongate material across its longest dimension can be tubular, solid, or of an open construction such as L-shaped, T-shaped, V-shaped, U-shaped, W-shaped, etc. Though not intended as limiting, the elongate material can be comprised of metals, plastics, ceramics, rubbers, and/or any combination thereof.

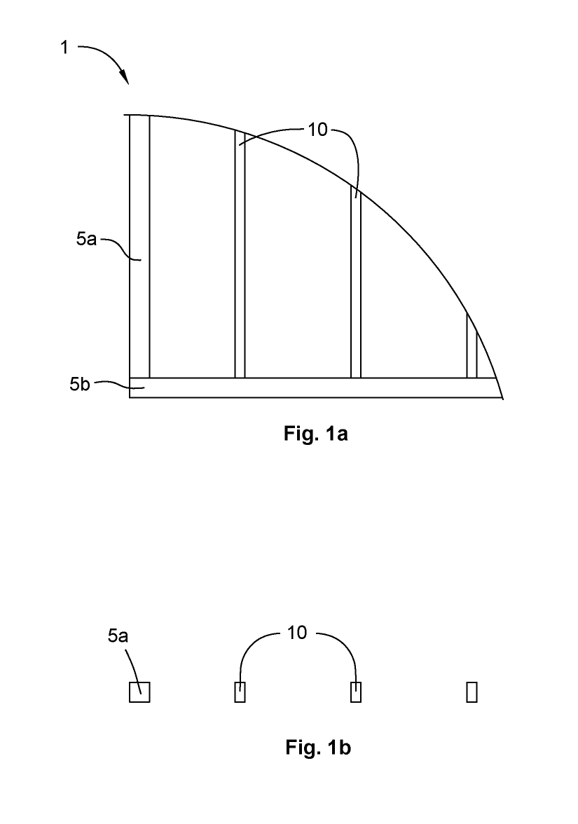

In FIGS. 1a-b a standard screen frame 1 is shown. As shown the screen frame 1 is constructed of elongate transverse portions 5a, elongate longitudinal portions 5b, and middle supports 10. As shown in FIG. 1b, the portions 5a and 10 are rectangular in cross section. Here they are shown as tubing. Longitudinal portion 5b as shown in FIG. 1b is the other longitudinal portion of the frame 1 running parallel to the longitudinal portion 5b actually shown in the partial top view of the frame 1 in FIG. 1a. To be clear, there are in fact two longitudinal portions 5b of the frame 1. Only one is shown in FIG. 1a. The longitudinal portion 5b shown in FIG. 1b is the longitudinal portion that is not shown in FIG. 1a.

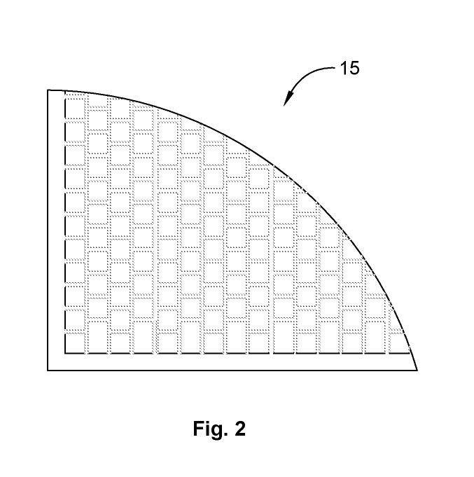

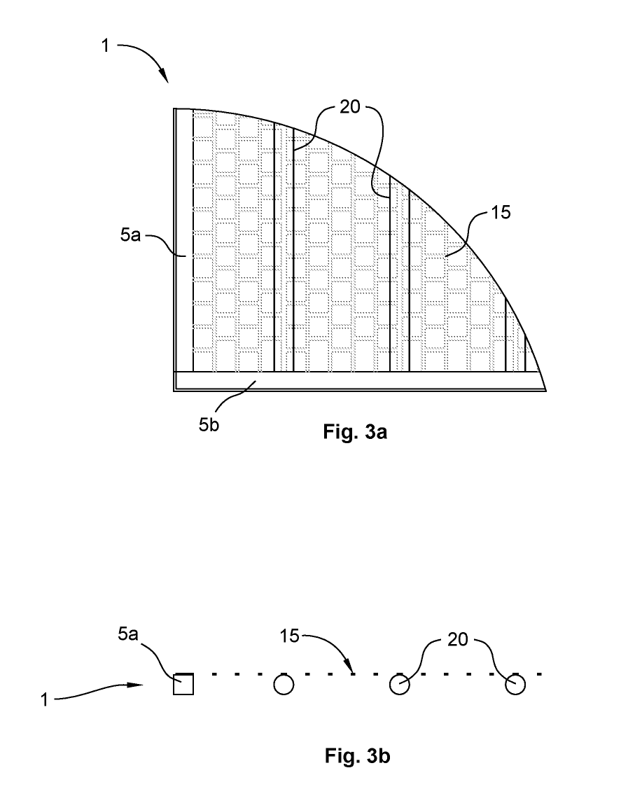

FIG. 2 shows a standard plate 15. The plate 15 is perforated and can be included on a screen frame. In FIGS. 3a and 3b a standard plate 15 is shown together with an inventive screen frame 1 having transverse portions 5a, longitudinal portions 5b, and rounded middle supports 20. In FIG. 3b the frame 1 and perforated plate 15 are shown in cross-section. Longitudinal portion 5b is not shown in order to better show the standard plate 15. If shown longitudinal portion 5b would look similarly to the longitudinal portion 5b of FIG. 1b. The middle supports 20 are substantially circular as shown and the transverse frame portion 5a is shown as rectangular/square. The frame periphery 5a/5b can have different cross-sectional geometric shapes (e.g. a simple angle or U-shape with one leg of the angle or U shape oriented parallel to the perforated plate or screen). The transverse portions 5a and/or the supports 20 can also extend in a direction oblique to that of the longitudinal portions 5b of the frame 1.

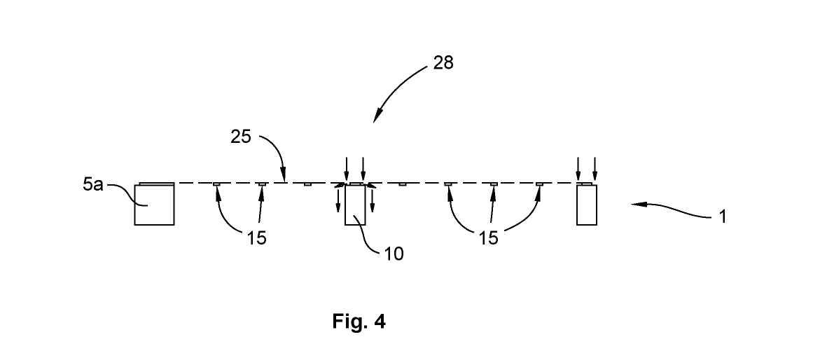

A screen frame 1 having rectangular middle supports 20 is shown in FIG. 4. The screen frame 1 supports a perforated plate 15 with a screen 25 thereon indicated by the dashed line. As illustrated, fluid 28 is impeded through the portions of the screen fabric 25 that is disposed over the rectangular middle supports 10. Obviously this slows the passage of fluid through the screen fabric 28 and diminishes the effectiveness of the screen.

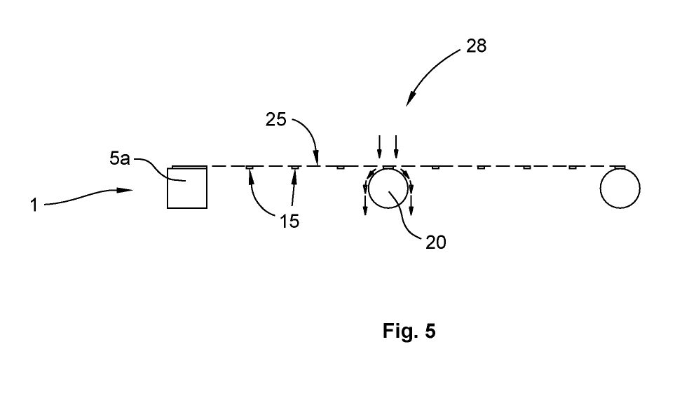

In FIG. 5, the inventive screen frame 1, with transverse elongate portion 5a and substantially circular middle portions 20, provides improved fluid flow 25 through the screen fabric 25. As shown, the fluid flow 28 is less impeded with more circular or oval middle supports 20. The fluid can pass through the screen fabric 25 over a larger area because the contact area between the support 20 and plate/screen fabric 15/25 can be smaller than a contact area having a flatter geometry as in FIG. 4.

In some embodiments, the supports 20 can extend substantially longitudinally from the transverse elongate portions 5a. In some embodiments supports 20 can extend from both the transverse elongated portion 5a and the transverse elongated portion 5b. In some embodiments the support struts 20 extend in a diagonal direction from the longitudinal and/or transverse direction. In all such embodiments, the supports 20 having an ovular shape in cross-section can be used.

In some embodiments, one by one inch openings are used with the perforated plates, though larger and smaller openings can be used.

The ovular/circular members provide greater torsional rigidity than does a rectangular tube of similar size

For the purposes of this disclosure, like reference numerals in the figures shall refer to like features unless otherwise indicated.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A screen for a vibrating screen device, the screen having a frame and a screen surface, the frame having a periphery and a middle portion, the periphery constructed of elongate material portions, the middle portion having middle supports, the middle supports including tubing having a cross-section of an ovular shape.

2. The screen of claim 1 wherein the periphery is constructed of rectangular tubing having transverse portions and longitudinal portions.

3. The screen of claim 1 wherein the periphery is constructed of angle or U-shaped material having transverse portions and longitudinal portions.

4. The screen of claim 1 wherein the middle supports extend transversely between longitudinally extending portions of the frame.

5. The screen of claim 1 wherein the middle supports have a cross-section of a shape selected from a group having a shape that is round, substantially circular, substantially semi-circular, substantially elliptical, egg-shaped, oval, or any combination thereof.

6. The screen of claim 1 wherein the screen surface is supported by a perforated plate.

7. The screen of claim 6 wherein the middle supports contact the perforated plate at contact points that are less than one half the widest width of the middle supports in cross section.

8. The screen of claim 1 wherein half or more of the middle supports have a cross-section of an ovular shape.

9. A screen for a vibrating screen device, the screen having a frame and a screen surface, the frame having a periphery and a middle portion, the periphery of elongate material having transverse portions and longitudinal portions, the screen surface attached to a perforated plate, the middle portion having middle supports, the middle supports including tubing having a cross-section of an ovular shape, the middle supports extending transversely between longitudinally extending portions of the frame.

10. The screen of claim 9 wherein the periphery is constructed of rectangular tubing having transverse portions and longitudinal portions.

11. The screen of claim 9 wherein the periphery is constructed of angle or U-shaped material having transverse portions and longitudinal portions.

12. The screen of claim 9 wherein the middle supports have a cross-section of a shape selected from a group having a shape that is round, substantially circular, substantially semi-circular, substantially elliptical, egg-shaped, oval, or any combination thereof.

13. The screen of claim 9 wherein the middle supports extend transversely between longitudinally extending portions of the frame.

14. The screen of claim 9 wherein the screen surface is supported by a perforated plate.

15. The screen of claim 14 wherein the middle supports contact the perforated plate at contact points that are less than one half the widest width of the middle supports in cross section.

16. A screen for a vibrating screen device, the screen having a frame and a screen surface, the frame having a periphery and a middle portion, the periphery constructed of rectangular tubing having transverse portions and longitudinal portions, the screen surface attached to a perforated plate, the middle portion having middle supports, the middle supports including tubing having a cross-section of an ovular shape, the middle supports extending transversely between longitudinally extending portions of the frame.

17. The screen of claim 16 wherein the screen surface is supported by the perforated plate.

18. The screen of claim 17 wherein the middle supports contact the perforated plate at contact points that are less than one half the widest width of the middle supports in cross section.
